(19) United States
(12) Patent Application Publication
(10) Pub. No.: US 2001/0055122 A1
(43) Pub. Date: Dec. 27, 2001

(54) Adaptive autobackground suppression to compensate for integrating cavity effect

(75) Inventors: Ramesh Nagarajan, Fairport, NY (US); Francis K. Tse, Rochester, NY (US); Thomas R. Beikirch, Rochester, NY (US); David C. Craig, Rochester, NY (US)

Correspondence Address: Patent Documentation Center, Xerox Corporation, Xerox Square, 20th Floor, 100 Clinton Ave. S., Rochester, NY, 14644, US

(73) Assignee: Xerox Corporation

(21) Appl. No.: 09/918,014

(22) Filed: Jul. 30, 2001

Related U.S. Application Data
(62) Division of application No. 09/159,038, filed on Sep. 23, 1998.

(51) Int. Cl. H04N 1/407; G06T 5/40; G06K 15/02

(52) U.S. Cl. 358/1.9; 382/172; 382/169; 382/274; 382/275

(57) ABSTRACT

A system and method suppresses automatically a background of a document being scanned. A histogram circuit generates a histogram from a predetermined group of scanlines of image data collected at a lead edge of the document being scanned, and a gain correction circuit calculates a gain value from the histogram and applies the gain to the image data. The histogram circuit generates a next histogram from a next predetermined group of scanlines of image data collected from the document being scanned. The gain correction circuit then calculates a next gain value from the next histogram. A comparator enables the application of the next gain value to the image data if the next gain value is less than a previously calculated gain value.

### FIELD OF THE INVENTION

This invention pertains to methods and apparatus for determining background content of an image of a scanned document. More particularly, this invention relates to a method for determining the document background and suppressing its effects on document copies. The present invention describes a way to accurately suppress the background of a scanned image without affecting the productivity of copying, by continuously sampling histogram data from the lead edge of an input image and an appropriate gain is computed.

### BACKGROUND OF THE PRESENT INVENTION

In copier systems, copying a document (or more generally, an original) while suppressing the substrate of the original is often required, such as when the original is printed on colored paper. Background detection can be performed on just the leading edge of the document or the whole document. However, whole page background detection generally requires pre-scanning the entire original. The detected background can be removed by adjusting the gain of the scanned image and clipping the values that exceeds the system processing range.

One approach to estimating the original's background value is by performing a running average in an area of the original where there is just background. This approach also blocks using any video below a selectable threshold just in case non-background material is included in the selected area. This running average approach works well with pure background, but performs poorly when non-background material is present, especially when the non-background material occurs at the edge of the window where the final average is most affected.

Automatic background suppression senses the background and automatically suppresses the background before final printing. Conventional automatic background suppression systems generate a histogram of the document using standard methods and then calculate the mean and standard deviation. This often involves significant amounts of calculation to determine the gain needed to eliminate the background noise.

Moreover, an auto background suppression or automatic exposure feature in digital copiers detects the background value of the input document and automatically suppresses the background gray without any user intervention/adjustment. This background detection is performed by analyzing the lead edge statistics of the document as illustrated in FIG. 16 wherein a group of scanlines 900 are collected to generate a histogram for the input document 800. This histogram represents the lead edge statistics for the input document 800, and a gain value to compensate for the background is computed from the histogram. If the document is scanned through a DADF, the histogram for lead edge statistics calculation is collected at approximately 1.25 millimeters into the registered document as illustrated in FIG. 16.

On the other hand, if the document is placed on the platen without any document sensing feature enabled, a short prescan is performed. A histogram then is collected at approximately 10 millimeters from the platen registration corner as shown in FIG. 17, wherein the group of scanlines 900 have a greater offset from the lead edge than the group in FIG. 16.

It is noted that during platen scanning, the scanner takes its initial histogram at the 10 millimeter point because of lack of knowledge of the exact position of the document. For example, documents can get skewed while closing the platen cover resulting in collecting data from the platen cover if the histogram is collected at 1.25 millimeters from the registration corner. Another reason is due to the “incorrect” information present within the first few millimeters of the registration corner due to the integrating cavity effect (ICE) from the underside of the platen cover which is a common problem in most of the document scanners.

A sample of image data collected from a scan of a white piece of paper in DADF and a white piece of paper on a platen is shown in FIG. 18. As shown in FIG. 18, the video collected in the lead edge of the document tends to be darker than actual gray level for platen scanning as compared to DADF scanning due to the integrating cavity effect from the platen cover. Thus, the computed gain is higher for a platen scan than the preferred value to compensate for the background. This results in highlight areas of the document being washed out and in general the density of the document not being perfectly reproduced.

One proposed solution to this problem with platen scanning is to conduct a pre-scan of the input document to facilitate the generation of a more accurate histogram from which to compute the gain value. The drawback of using a short prescan for collecting histogram data is the “productivity hit” that occurs because of an additional scan for each input document.

To avoid the “productivity hit,” one can collect histogram data at the lead edge of the document and compensate for integrating cavity effect by using some adjustment factor. However, the difficulty is in coming up with a general adjustment factor that can work well with various types of document placed at different locations on the platen. Therefore, it is desirable to provide a process which accurately computes the gain of a document being scanned on a platen while avoiding any “productivity hit.”

The present invention accurately suppress the background of a scanned image without affecting the productivity of copying, by continuously sampling histogram data from the lead edge of an input image and an appropriate gain is computed. Gain values are interpolated and applied to the image as frequently as possible resulting in a true reproduction of the original input image.

### SUMMARY OF THE PRESENT INVENTION

One aspect of the present invention is a method of suppressing automatically a background of a document being scanned. The method generates a histogram from a predetermined group of scanlines of image data collected at a lead edge of the document being scanned; calculates a gain value from the histogram and applying the gain to the image data; generates a next histogram from a next predetermined group of scanlines of image data collected from the document being scanned; calculates a next gain value from the next histogram; and applies the next gain value to the image data if the next gain values is less than a previously calculated gain value.

Another aspect of the present invention is a system of suppressing automatically a background of a document being scanned. The system includes a histogram circuit to generate a histogram from a predetermined group of scanlines of image data collected at a lead edge of the document being scanned and a gain correction circuit to calculate a gain value from the histogram and applying the gain to the image data. The histogram circuit generates a next histogram from a next predetermined group of scanlines of image data collected from the document being scanned, and the gain correction circuit calculates a next gain value from the next histogram. A comparator applies the next gain value to the image data if the next gain value is less than a previously calculated gain value.

These and other features and advantages of this invention are described in or apparent from the following detailed description of the preferred embodiments.

### BRIEF DESCRIPTION OF THE DRAWINGS

The preferred embodiments of this invention will be described in detail, with reference to the following figures, wherein:

FIG. 1 is an input document;

FIG. 2 is a histogram of the input document;

FIG. 3 is a graphical representation of the histogram of the input document;

FIG. 4 is a compressed or smoothed histogram of the input document generated from the histogram of FIG. 3;

FIG. 5 is a graphical representation of the compressed or smoothed histogram of the input document generated from the histogram of FIG. 3;

FIG. 6 is another histogram of the image of the input document;

FIG. 7 is a graphical representation of the other histogram of the image of the input document;

FIG. 8 is a is a graphical representation of a compressed or smoothed histogram generated from the histogram of FIG. 7;

FIG. 9 is a larger scale graphical representation of a compressed or smoothed histogram;

FIGS. 10A-10C are the tone reproduction curve map of Equations 17, 18 and 19; and

FIGS. 11A-11D are images of a newspaper photograph;

FIGS. 12A and 12B are flowcharts of methods relating to the present invention;

FIG. 13 is a block diagram of an apparatus relating to the present invention;

FIG. 14 is a block diagram of the mean grey-level and standard deviation calculation circuit;

FIG. 15 is a histogram window generator circuit;

FIG. 16 is a graphical representation of an input document with an initial histogram;

FIG. 17 is a graphical representation of an input document with a histogram

FIG. 18 is a graphical representation of the integrating cavity effect on an input document;

FIG. 19 is a graphical representation of an input document with a series of histograms, according to the concepts of the present invention;

FIG. 20 is a graphical representation of a gain profile, according to the concepts of the present invention;

FIG. 21 is a block diagram showing a gain control architecture, according to the concepts of the present invention; and

FIG. 22 is a flowchart showing the gain control process, according to the concepts of the present invention.

### DESCRIPTION OF THE PREFERRED EMBODIMENTS

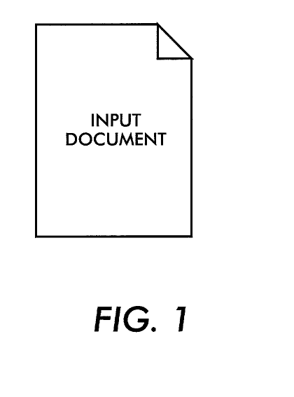

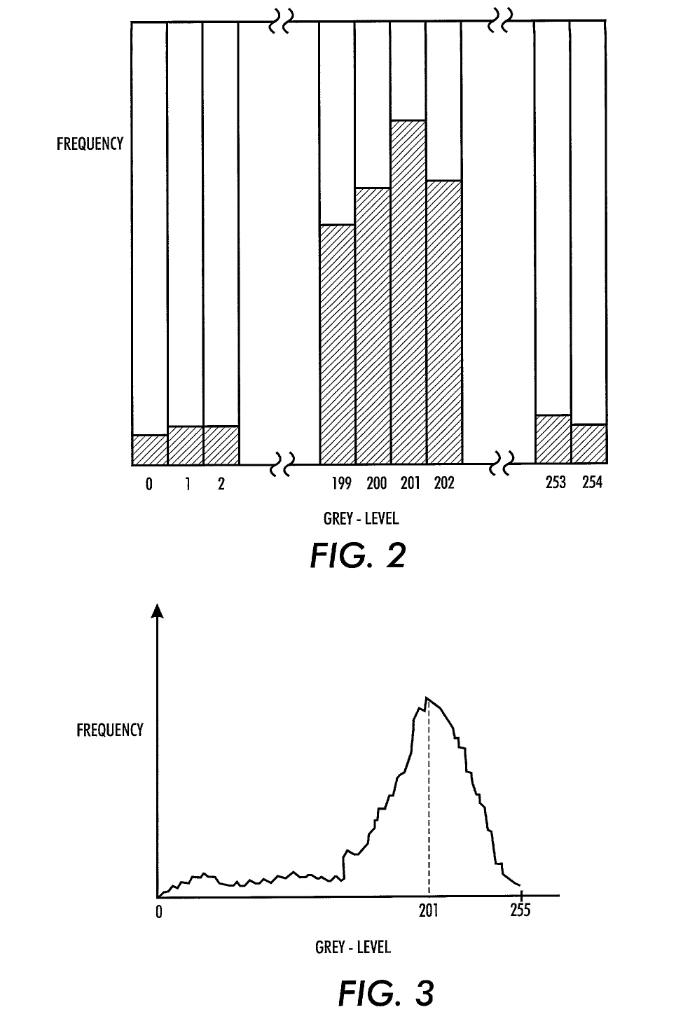

FIG. 1 shows an input document. The input document is scanned and analyzed to generate the histogram shown in FIG. 2. Preferably, a small sampling window of approximately 4,000 pixels by four scanlines is applied to the leading edge of the input document to generate the histogram. The histogram of the input document shown in FIG. 2 is a 256-value histogram of the grey levels of the input document, wherein a grey-level of 0 represents the black pixels and a grey-level of 255 represents the white pixels. The pixel value having the highest frequency in the sampling window represents the mean grey-level of the background. For example, the mean grey-level of the background of the input document is “201,” as shown in FIGS. 2 and 3. FIG. 3 is a graphical representation of the histogram shown in FIG. 2.

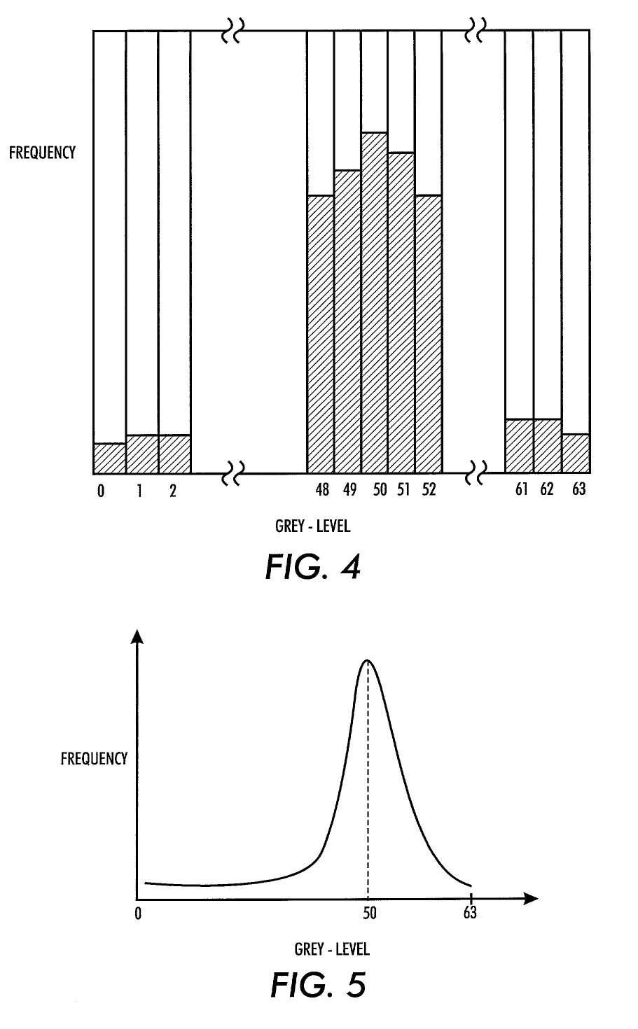

The generated histogram is then smoothed or compressed. In general, histogram data tends to be noisy and smoothing the histogram data is desirable. One preferred approach to smoothing the histogram is to combine pixel values. In the preferred embodiment of the method of this invention, the range of grey-level values is divided into non-overlapping subsets of four values each. The frequency values for the four grey-level values in each subset are added together and divided by four to obtain an average frequency value for each subset of grey-level values. These new grey-level values represent different grey-levels in the input document, ranging from the darkest grey-level value to the lightest grey-level value. Thus, an original histogram with 256 grey-level values, for example, is compressed into a histogram of 64 grey-level values, as shown in FIG. 4. FIG. 5 is a graphical representation of the compressed histogram shown in FIG. 4. In particular, the background mean grey-level of the input image is represented by a value of grey-level 50 in the compressed histogram shown in FIGS. 4 and 5. This value of 50 is an estimation of the background mean grey-level value due to the smoothing process. The exact mean grey-level value will be determined as detailed below.

Devices capable of scanning an input document, generating a histogram of the input document and compressing the histogram are well known in the art. Thus, a detailed description of the operation of these devices is omitted.

The first embodiment of the method of this invention then approximates the shape of the histogram using a second order polynomial of the form

y=ax²+bx+c (1)

where:

y is the grey-level value frequency, i.e., the number of pixels having that grey-level value; and

x is the grey-level value.

The second order polynomial is fit to three points of the compressed histogram The points selected include the grey-level frequencies of the grey-level value having the highest frequency and the grey-level values immediately adjacent to the grey-level value having the highest frequency in the compressed histogram. In another preferred approach, the grey-level having the highest frequency is selected and the two neighboring grey-level values having frequencies closest to e^{-0.5} times the highest frequency are located. This results in a slightly improved prediction and a more general solution since it is not restricted to only two possibilities. The equations that represent the three points, corresponding to the highest occurrence frequency and the two adjacent grey-level values, are:

y₁=ax₁²+bx₁+c;

y₂=ax₂²+bx₂+c; and

y₃=ax₃²+bx₃+c.

where:

yᵢ represents the y-coordinate on the histogram (i.e. the occurrence frequency) of the ith point; and

xᵢ represents the x-coordinate on the histogram (i.e. the grey-level value) of the ith point.

Linear algebra can be used to solve for the coefficients a, b and c. The curve generated by the resulting equation closely approximates the compressed histogram of the background video data. The peak value of the curve and its spread or standard deviation can then be calculated.

Assuming the histogram has a normal probability distribution and that the curve of the quadratic equation and the curve of the normal probability function are equivalent in the region near the curve peak, the distribution curve is:

y=Ke^{-((x-x}^{ₘ}⁾^{²}^{/2σ)} (2)

where:

xₘ is the x-coordinate value of the mean;

K is the y-coordinate value of the mean;

σ is the standard deviation.

When approximating the points to a normal distribution, xₘ is equivalent to xₘₐₓ and yₘ is equivalent to yₘₐₓ of the curve of the quadratic equation.

The value of x at one standard deviation from xₘ is:

x=xₘ+σ (3)

Solving for σ gives:

σ=x−xₘ (4)

The value of y at that point is:

y=yme−0.5. (5)

From the quadratic equation, the value of x is:

x=(−b+(b2−4a(c−y))½)/2a. (6)

Substituting Equation 3 and Equation 5 into Equation 4 gives:

σ=((−b+(b2−4a(c−yme−0.5))½)/2a)−xm (7)

The gain factor is the final output and is defined as the “white” pixel value, i.e., a grey-level value of 255, divided by the background “white” pixel value of the input document V_{w}. V_{w} is defined as:

Vw=xm−nσ (8)

where n is an arbitrary multiplier. Thus, the gain G is:

G=255/Vw. (9)

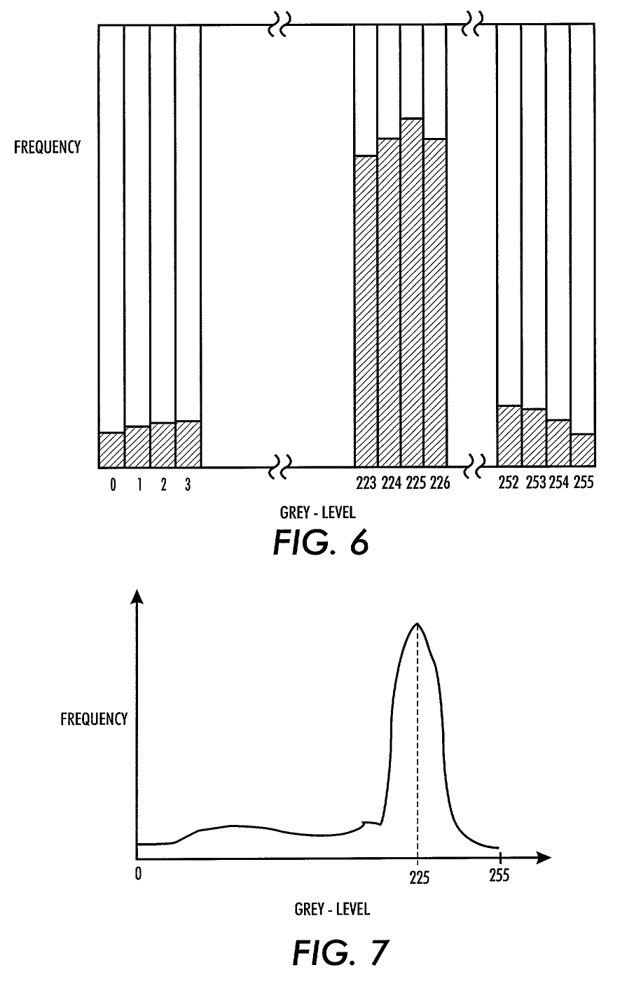

The gain G is then multiplied by the grey-level values 0 to 255 of the histogram shown in FIG. 1 to obtain the histogram of the image of the input document shown in FIG. 6. As shown in FIG. 7, the peak of the histogram of the image of the input document is shifted to a value of 225, i.e., towards the grey-level “white” value of 255, from a value of 201. Thus, the background grey-level value BKG of the image of the input document is represented by a grey-level value of 225. In the histogram of the image of the input document, any grey-level value exceeding a value of 225 is clipped.

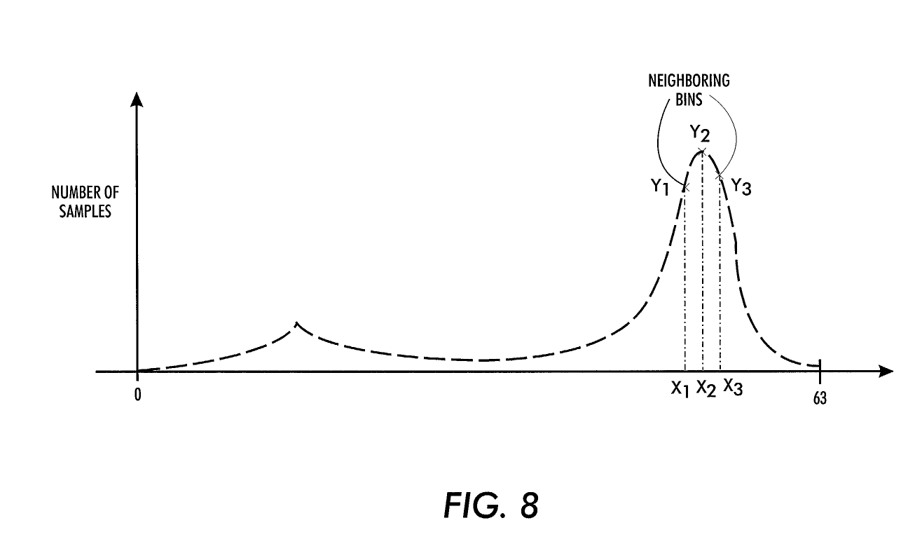

A second preferred embodiment of the method for determining the standard deviation of the compressed histogram of the input document initially includes determining the peak (x₂,y₂) of the compressed histogram and its neighboring points (x₁,y₁) and (x₃,y₃) as shown in FIG. 8, where x₁, x₂ and x₃ are the grey-level values and y₁, y₂ and y₃ are the corresponding histogram occurrence frequency values.

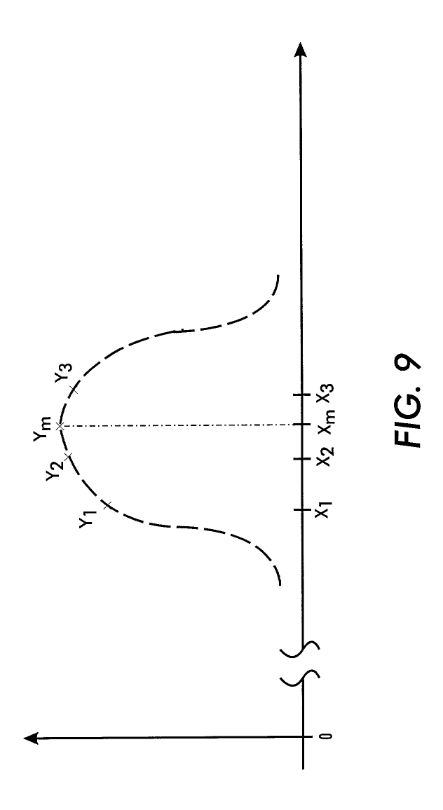

Next, as shown in FIG. 9, the background mean grey-level is determined using a weighted average of the three grey-level values previously obtained:

$$Mean ( {x}_{m} ) = \frac{\sum {x}_{i} {y}_{i}}{\sum {y}_{i}} , i = 1 to 3. \qquad ( 10 )$$

Finally, instead of fitting the three sampled points into a quadratic equation and approximating the result to a normal distribution, as in the first preferred embodiment, the three Cartesian coordinates and the computed mean are directly used in the normal distribution equation. The normal distribution equation is:

y=Ke^{-((x-μ)}^{²}^{/2σ}^{²}⁾ (11)

where μ and σ are the mean and the standard deviation of the distribution, respectively. By approximating the points to a normal distribution, the following equations are obtained:

μ=xₘ; and (12)

K=yₘ. (13)

Using two Cartesian pairs and the value of xₘ, the standard deviation for the distribution is:

$$σ = \sqrt{\frac{8 ( {x}_{2} + {x}_{p} - 2 {x}_{m} )}{{log}_{e} ( {y}_{2} / {y}_{p} )}} . \qquad ( 14 )$$

The factor of 8 arises due to the interpolation required to interpolate the 64-value histogram values xᵢ into 256 grey levels. To solve for the standard deviation of the normal distribution, two points are needed since yₘ is an unknown variable. In the second preferred embodiment of the method, the peak (x₂,y₂) and the closest x-axis coordinate xp to the value of xₘ and its corresponding y-axis coordinate (xₚ,yₚ) are preferably used. For example, in FIG. 9 (xₚ,yₚ)=(x₃,y₃). However, if there is little variation in the y-axis coordinates and y₃ is closer to y₂ than y₁ is to y₂, then (xₚ,yₚ) is preferably set to (x₁,y₁) instead of (x₃,y₃).

The gain factor G is thus:

G=255/(V_{w}−V_{b}) (15)

where V_{b} is the lowest or “blackest” grey-level value of the histogram of the input document. Ideally V_{b} is equal to zero. V_{w} is defined as:

V_{w}=xₘ−L_{w}(3σ+0.108+0.0948xₘ) (16)

where L_{w} is a constant.

To convert images into binary information, a single fixed threshold is often applied. If a pixel in the image is above a threshold level, a binary “1” is produced, otherwise, a binary “0” is produced. Selecting a fixed threshold value is thus critical. Using a threshold value which is too high results in an unnecessary loss of information. In contrast, a threshold value which is too low brings out objectionable background noise.

However, selecting the threshold is non-trivial. Locating the threshold value by trial and error with test prints or displays can be used to select the threshold value. However, this method is unsatisfactory. Preferably, the threshold value should be selected automatically.

One method for automatically selecting the threshold value uses a fixed, nominal threshold value which is one-half the available dynamic range. This method then modifies the dynamic range of an image via a linear transformation, (i.e., a tone reproduction curve map). Ideally, the tone reproduction curve map should produce the best shadow and detail rendition without reproducing the background pixels of the image.

One preferred method for modifying the dynamic range is:

$${P}_{NEW} = ( {P}_{OLD} - {R}_{MIN} ) * \frac{( {Z}_{MAX} - {Z}_{MIN} )}{( {R}_{MAX} - {R}_{MIN} )} \qquad ( 17 )$$

where:

P_{NEW} is the adjusted pixel grey-level value;

P_{OLD} is the original pixel grey-level value;

(Zₘₐₓ−Zₘᵢₙ) is the largest possible dynamic range for the system;

Rₘₐₓ is the image reflectance value where the sum of the image area which contains reflectances above Rₘₐₓ is less than a prescribed percentage of the total image area; and

Rₘᵢₙ is the image reflectance value where the sum of the image area which contains reflectances below Rₘᵢₙ is less than a prescribed percentage of the total image area.

Rₘᵢₙ and Rₘₐₓ allow a greater “range,” in order to stretch the rest of the grey levels. However, Rₘₐₓ and Rₘᵢₙ, instead of the absolute minimum and maximum reflectance values within an image, cause Eq. 17 to effectively compress the grey level ranges of P_{OLD}<Rₘᵢₙ and P_{OLD}>Rₘₐₓ by saturating them. This is usually tolerable, because very few pixels have grey levels in these ranges. Thus, little image information is lost.

A second preferred method for modifying the dynamic range is:

$${P}_{NEW} = ( {P}_{OLD} - {R}_{MIN} ) * \frac{white}{( BKG - {R}_{MIN} )} \qquad ( 18 )$$

where:

BKG is the image background grey level as determined above; and

“white” is the reflectance of white paper or the “whitest white” determined during a scanner calibration process.

Eq. 18 differs from Eq. 17 in that instead of the entire input grey-level range of the particular image being mapped, as in Eq. 17, only those grey-levels between Rmin and the background level of the document are mapped by Eq. 18.

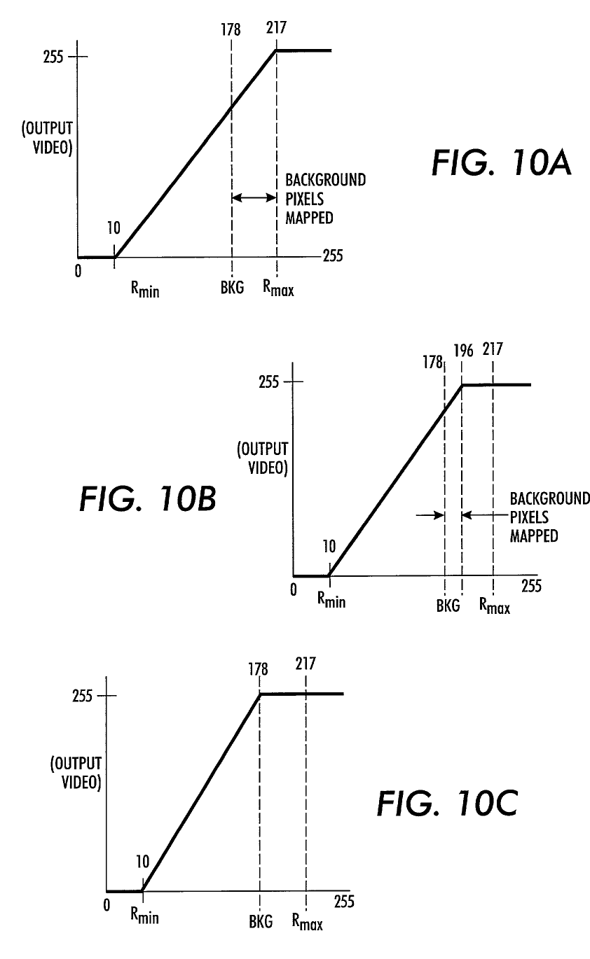

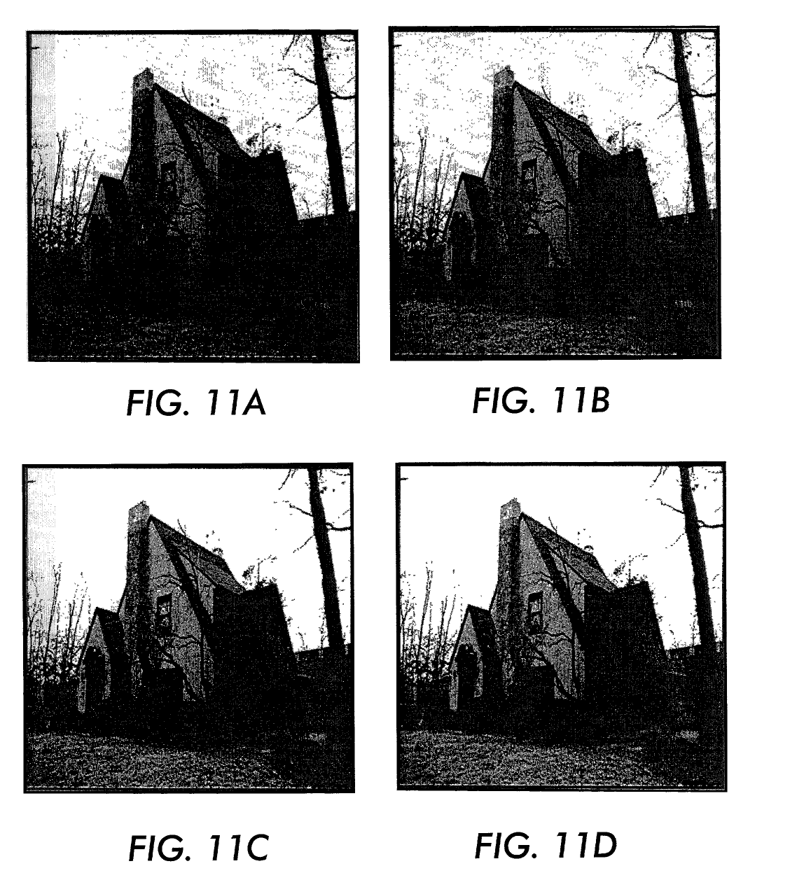

FIGS. 10A and 10B show the difference in the tone reproduction curves resulting from Equations 17 and 18, respectively, wherein Rₘᵢₙ=10, Rₘₐₓ=217, and the image background is determined as 178. Both methods slide the peak of the histogram to the left 10 grey-levels (Rₘᵢₙ). This maps more grey-levels to saturated black, increasing the contrast and the effective sharpness of the image.

When the maximum output dynamic range is 255, the first preferred method produces a linear map which maps input grey levels between Rₘᵢₙ and Rₘₐₓ to output grey-levels 0 to 255. Note that for this example, all grey-levels between Rₘᵢₙ and Rₘₐₓ will be mapped to the full grey scale range of 0 to 255, although the range could have been compressed by using the whitest white instead of 255.

For this example, the second preferred method produces a linear map between Rₘᵢₙ and the background value. Thus, a smaller subset of the grey-levels will be mapped to the output grey scale range from zero to “white”, the reflectance of white paper. Pixels having grey-level values above the background grey-level value will be saturated. However a smaller number of grey-level values will be mapped to available grey-levels using the second preferred method. The second preferred method maps more dark inputs grey pixels to the output, so more shadow detail will be visible. However, 21 grey-levels (Rₘₐₓ−196) in the highlight region will be saturated white. This may result in some visible, saturated white areas in the resultant image.

The tone reproduction curve maps generated by the two methods are often quite similar. If the difference between the image background and Rₘₐₓ is relatively small (<20), the tone reproduction curve map generated by the second preferred method approaches the tone reproduction curve generated for the first preferred method. If the maximum dynamic range in the first preferred method is decreased, the saturation point moves higher than Rₘₐₓ This effectively maps more input grey-levels in the highlight region, but wastes output grey-levels, since input grey levels higher than Rₘₐₓ will be mapped instead of saturated.

If the “white” term in Equation 18 is changed to “255” or the maximum possible output grey-level range, the transformation becomes a shift and linear stretch between Rₘᵢₙ and the image background. This is illustrated in FIG. 10C. Thus, all pixels having grey levels above the image background level will be saturated white. This will also map more dark input grey-levels to the available range, but fewer light input grey-levels. This improved method of dynamic range modification is given by:

$${P}_{NEW} = ( {P}_{OLD} - {R}_{MIN} ) * \frac{( {Z}_{MAX} - {Z}_{MIN} )}{( BKG - {R}_{MIN} )} \qquad ( 19 )$$

where:

P_{new} is the adjusted pixel grey-level value;

P_{OLD} is the original pixel grey-level value;

(Zₘₐₓ−Zₘᵢₙ) is the largest possible dynamic range for the system;

Rₘᵢₙ is the image reflectance value, such that the sum of the image area which contains reflectances below Rₘᵢₙ is less than a prescribed percentage of the total image area; and

BKG is the image background grey-level as determined above.

FIGS. 11A-11D show an image of a photograph wherein the threshold level=128. FIG. 11A is the image without dynamic range adjustment. FIG. 11B is the image with the dynamic range adjusted using Equation 17. FIG. 11C is the image with the dynamic range adjusted using Equation 18. FIG. 11D is the image with the dynamic range adjusted using Equation 19.

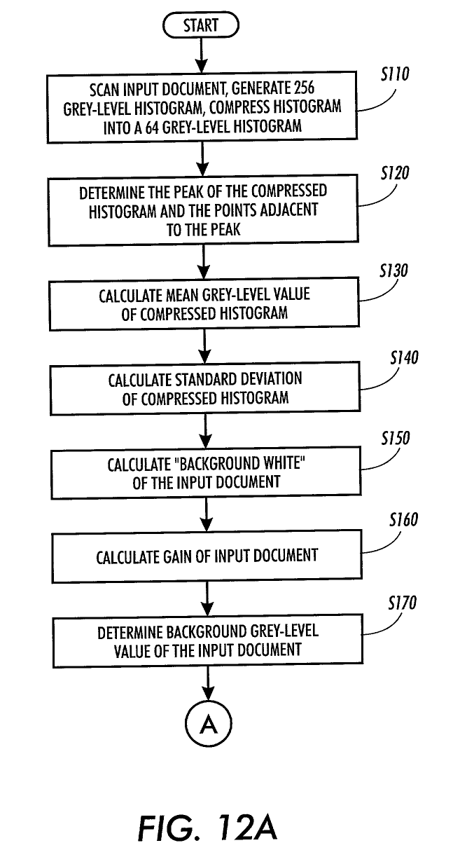

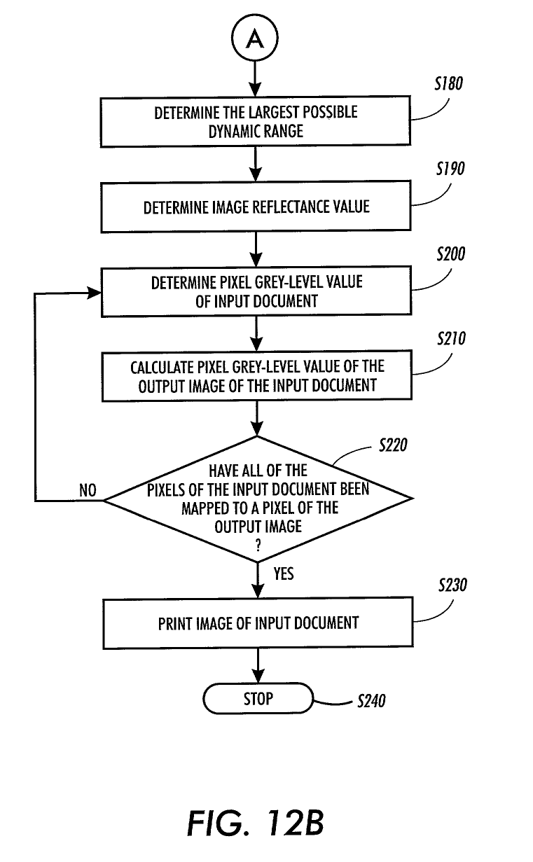

FIGS. 12A and 12B show one method for determining the background grey-level of an input document. After starting in step S100, control continues to step S110. In step S110, an input document is scanned, a 256 grey-level histogram is generated and the histogram is compressed into a 64 grey-level histogram In S120, the peak of the compressed histogram and the points adjacent to the peak are determined.

In step S130, the mean grey-level value of the compressed histogram is calculated. In the first preferred method, xₘₐₓ is equivalent to the mean. In the second preferred method, the mean is calculated using Equation 10.

In step S140, the standard deviation of the compressed histogram is calculated. In the first preferred method, the standard deviation is calculated using Equation 7. In the second preferred method, the standard deviation is calculated using Equation 14.

In step S150, the background white of the input document is calculated. In the first preferred method, the background white is calculated using Equation 8. In the second preferred method the background white, is calculated using Equation 16.

In step S160, the gain G of the input document is calculated. In the first preferred method, the gain G is calculated using Equation 9. In the second preferred method, the gain G is calculated using Equation 15.

In step S170, the background grey-level value is determined using the gain G. This value is used to determine the adjusted dynamic range of an image of the input document.

Next, in step S180, the largest possible dynamic range is determined. In step S190, the image reflectance value is determined. In step S200, the pixel grey-level values of the input document are determined. In step S210, the pixel grey-level values of an output image of the input document are calculated. In step S220, the control routine determines whether all of the pixels of the input document have been mapped to the pixels of the output image of the input document. If all of the pixels have not been mapped, control returns to step S220. If all of the pixel have been mapped, control continues to step S230. In step S230, the output image of the input document is printed. Control then continues to step S240, where the control routine stops.

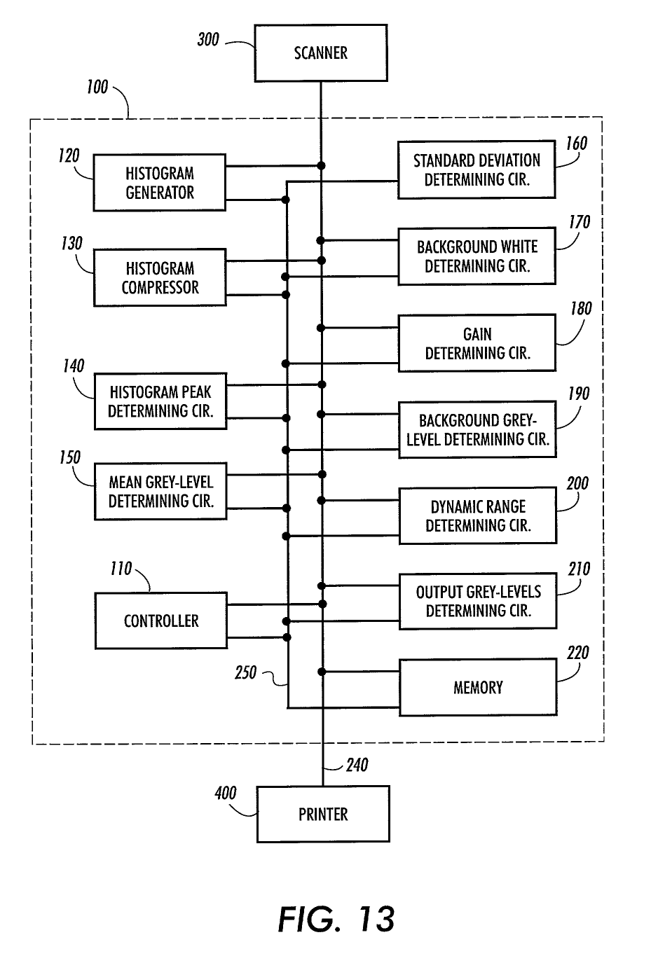

FIG. 13 shows a block diagram of a document background determining and dynamic range adjusting system 100 used to implement the preferred methods of this invention. The scanner 300 scans the input document. The histogram generator 120 generates a 256 grey-level histogram The histogram compressor 130 compresses the histogram into a 64 grey-level histogram The histogram peak determining circuit 140 determines the peak frequency values of the compressed histogram. The mean grey-level determining circuit 150 calculates the mean grey-level value of the compressed histogram. The standard deviation determining circuit 160 calculates the standard deviation of the compressed histogram. The background white determining circuit 170 calculates the “background white” of the input document. The gain determining circuit 180 calculates the gain of the input document. The background grey-level determining circuit 190 determines the background grey-level value of the input document. The dynamic range determining circuit 200 determines the dynamic range of an image of the input document. The output grey-level determining circuit 210 determines the output grey-level values of the output image of the input document. The memory 220 stores the output image of the input document. The controller 110 sends control signals to the various circuits 120-210 through a control bus 230. Data flows between the various circuits 120-210, the controller 110 and the memory 220 through a data bus 240. A printer 400 inputs the image of the input document and generates a hard copy of the image. The scanner 300 and the printer 400 are connected to the document background determining and dynamic range adjusting system 100 through the data bus 240.

As shown in FIG. 13, the system 100 is preferably implemented on a programmed general purpose computer. However, the system 100 can also be implemented on a special purpose computer, a programmed microprocessor or microcontroller and peripheral integrated circuit elements, an ASIC or other integrated circuit, a hardwired electronic or logic device such as a discrete element circuit, a programmable logic device such as a PLD, PLA, FPGA, or the like. In general, any device on which a finite state machine capable of implementing the flowcharts shown in FIGS. 12A and 12B can be used to implement the document background determining and dynamic range adjusting system 100.

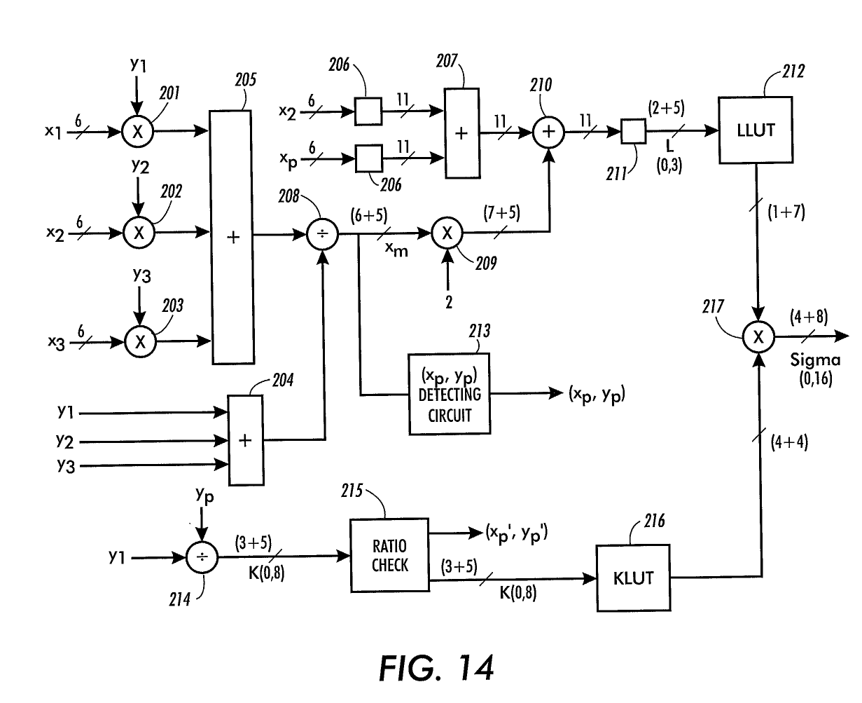

FIG. 14 shows one hardware implementation of the mean grey-level determining circuit S150 and the standard deviation determining circuit S160 using Equations 10 and 14, respectively. The input to these circuits are the peak (x₂,y₂) of the compressed histogram and its two neighboring points (x₁,y₁) and (x₃,y₃), as shown in FIG. 8. Each of the points is fed into the multipliers 201, 202 and 203. Their individual products (x₁*y₁), (x₂*y₂), (x₃*y₃) are computed. The resultants are then fed into the adder 205 to obtain (x₁*y₁+x₂*y₂+x₃*y₃). Simultaneously, the sum of the y₁−y₃ is computed through the adder 204. The obtained sum (y₁+y₂+y₃) and the result from the previous step are fed into the divider 208 to produce the mean grey-level xₘ, as shown in Equation 10.

The mean grey-level x_{M} is then fed into a detecting circuit 213 to determine the closest grey-level bin from x₁ and x₂ and its corresponding bin value. These points are shown in FIG. 14 as x_{P} and y_{P}, respectively. y_{P} and y₂ are then fed into a divider 214 to obtain the peak ratio K. This ratio K is tested to see if it is greater than a ratio limit in the ratio check circuit 215. If K is greater than the ratio limit, then (x_{P},y_{P}) is not modified. On the other hand, if K is less than or equal to the ratio limit, then x_{P} is replaced with the other point and y_{P} is replaced by its corresponding bin value to obtain (x_{P′},y_{P′}) and the new peak ratio K. The 8-bit (comprising a 3-bit integer and a 5-bit fraction) peak ratio K acts as an input to the KLUT circuit 216. The KLUT contains 256×8-bit look-up table LUT for the square root of an inverse natural logarithmic function \sqrt{8/logₑK}. Simultaneously, x₂ and x_{P′} are concatenated with leading zeros at the concatenating circuit 206 to obtain 11-bit numbers which are fed into an adder circuit 207. The mean grey-level x_{M} is shifted left by one bit at the multiplier 209 and subtracted from the output of the adder circuit 207 at the adder 210. The resultant (L=x₂+x_{P}−2xₘ) is reduced to a 7-bit number, comprising a 2-bit integer, at the truncation circuit 211 and is fed into LLUT circuit 212. The LLUT circuit 212 contains 128×8-bit LUT for a simple square root function \sqrt{L}. The outputs from the LUTs 216 and 212 are then fed into a multiplier 217 to obtain the standard deviation σ, as shown in Equation 14.

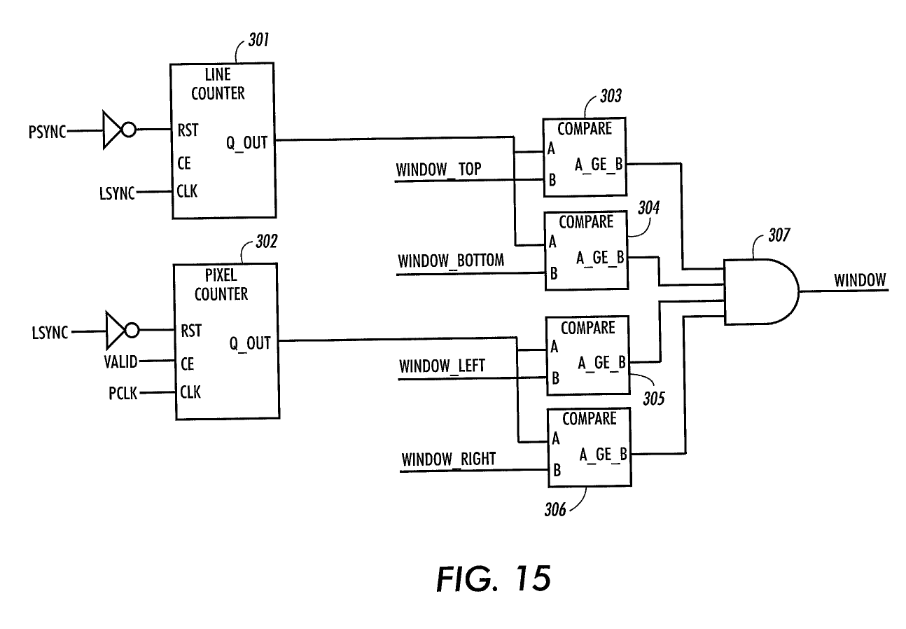

FIG. 15 shows the circuit which generates the histogram windows. The circuit could be programmed to collect a histogram within a rectangular window (as specified in the WINDOW TOP, WINDOW BOTTOM, WINDOW LEFT and WINDOW RIGHT signals) at any location within the input document. The line counter circuit 301 receives a page sync (PSYNC) signal and a line sync (LSYNC) signal from an image input terminal (IIT). The line counter circuit 301 increments a counter for each new input scanline data to keep track of the current line position. The IIT may be a digital platen scanner or a constant velocity transport digital scanner. The comparator circuits 303 and 304 determine if the given scanline is between the WINDOW TOP and WINDOW BOTTOM coordinate signals. The pixel counter circuit 302 receives the line sync signal (LSYNC), a video valid signal and a clock signal. The pixel counter circuit 302 increments a counter for each new valid input pixel to keep track of the pixel position within a particular scanline of data. The comparator circuits 305 and 306 determine if the given scanline is between the WINDOW LEFT and WINDOW RIGHT coordinate signals. The results of the comparators 303, 304, 305 and 306 are fed into an AND gate 307 to produce the output WINDOW signal. The WINDOW signal is therefore high or valid only when the current pixel being processed is within the specified rectangular window.

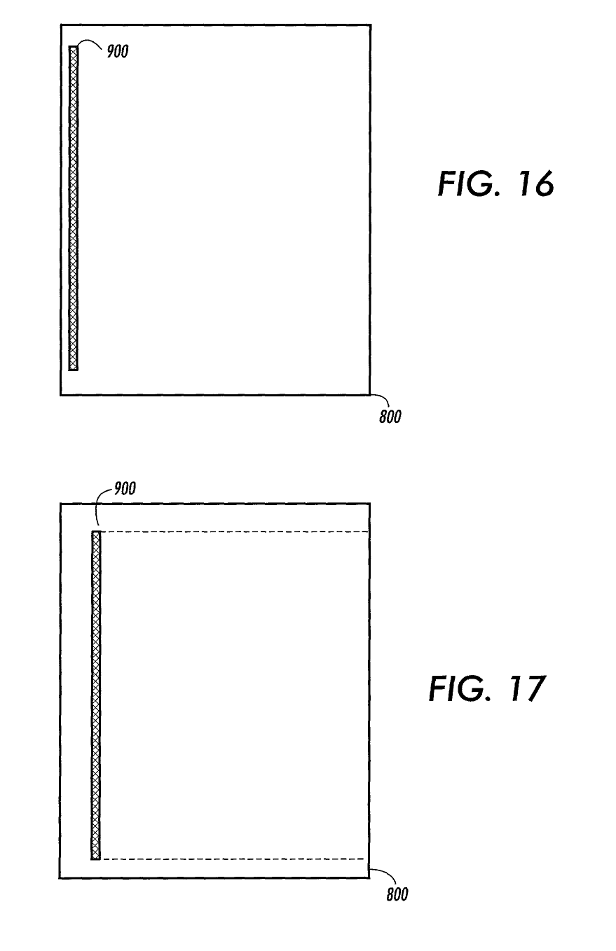

As been described above, an auto background suppression or automatic exposure feature in digital copiers detects the background value of the input document and automatically suppresses the background gray without any user intervention/adjustment. This background detection is performed by analyzing the lead edge statistics of the document as illustrated in FIG. 16 wherein a group of scanlines 900 are collected to generate a histogram for the input document 800. This histogram represents the lead edge statistics for the input document 800, and a gain value to compensate for the background is computed from the histogram. If the document is scanned through a DADF, the histogram for lead edge statistics calculation is collected at approximately 1.25 millimeters into the registered document as illustrated in FIG. 16.

On the other hand, if the document is placed on the platen without any document sensing feature enabled, a short prescan is performed. A histogram then is collected at approximately 10 millimeters from the platen registration corner as shown in FIG. 17, wherein the group of scanlines 900 have a greater offset from the lead edge than the group in FIG. 16.

It is noted that during platen scanning, the scanner takes its initial histogram at the 10 millimeter point because of lack of knowledge of the exact position of the document. For example, documents can get skewed while closing the platen cover resulting in collecting data from the platen cover if the histogram is collected at 1.25 millimeters from the registration corner. Another reason is due to the “incorrect” information present within the first few millimeters of the registration corner due to the integrating cavity effect (ICE) from the underside of the platen cover which is a common problem in most of the document scanners.

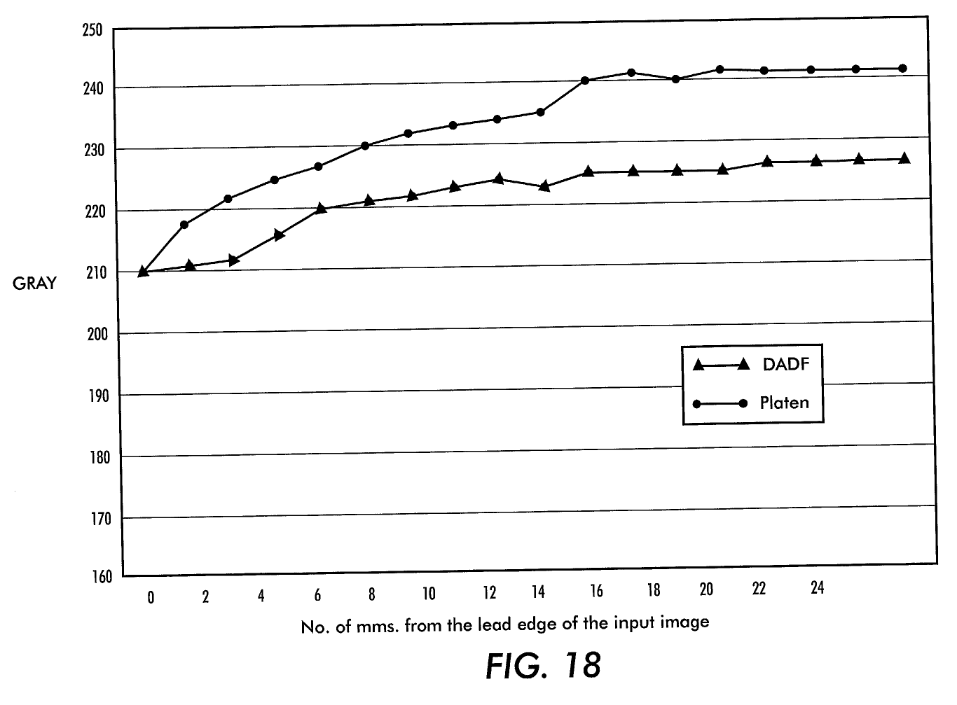

A sample of image data collected from a scan of a white piece of paper in DADF and a white piece of paper on a platen is shown in FIG. 18. As shown in FIG. 18, the video collected in the lead edge of the document tends to be darker than actual gray level for platen scanning as compared to DADF scanning due to the integrating cavity effect from the platen cover. Thus, the computed gain is higher for a platen scan than the preferred value to compensate for the background. This results in highlight areas of the document being washed out and in general the density of the document not being perfectly reproduced.

As noted before, one proposed solution to this problem with platen scanning is to conduct a pre-scan of the input document to facilitate the generation of a more accurate histogram from which to compute the gain value. The drawback of using a short prescan for collecting histogram data is the “productivity hit” that occurs because of an additional scan for each input document.

To avoid the “productivity hit,” one can collect histogram data at the lead edge of the document and compensate for integrating cavity effect by using some adjustment factor. However, the difficulty is in coming up with a general adjustment factor that can work well with various types of document placed at different locations on the platen. Therefore, it is desirable to provide a process which accurately computes the gain of a document being scanned on a platen while avoiding any “productivity hit.”

The present invention accurately suppress the background of a scanned image without affecting the productivity of copying, by continuously sampling histogram data from the lead edge of an input image and an appropriate gain is computed. Gain values are interpolated and applied to the image as frequently as possible resulting in a true reproduction of the original input image.

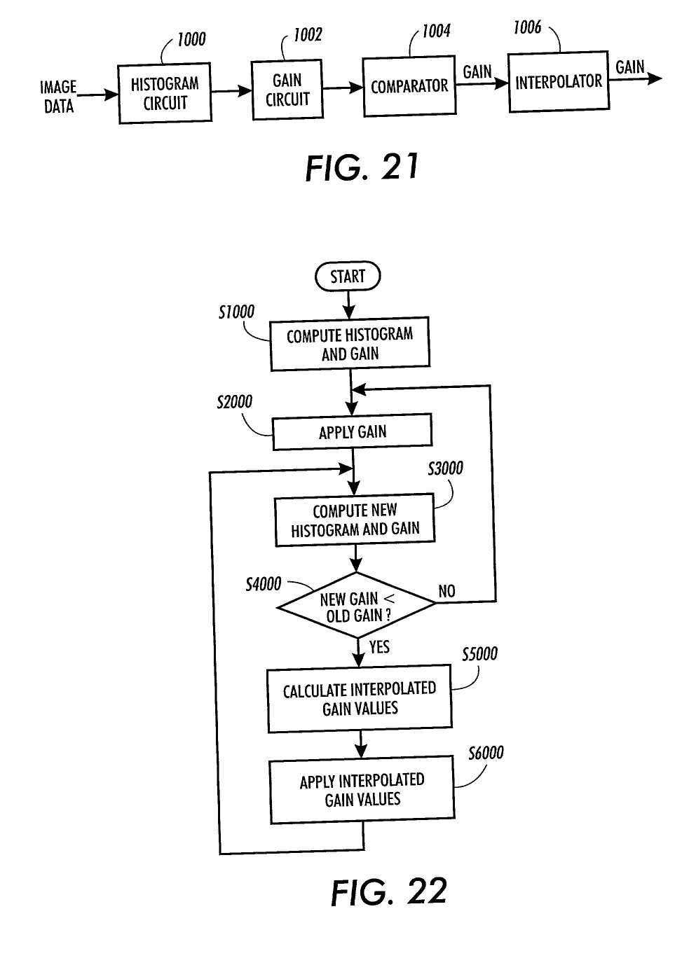

To realize a more accurate gain computation, the present invention, according to a preferred embodiment, initially collects four scanlines of image data at the lead edge of the document to generate a histogram in a histogram circuit 1000 of FIG. 21. From the histogram data, a gain value is computed in a gain circuit 1002 of FIG. 21 as illustrated by step S1000 of FIG. 22. After calculation of the gain value is completed, the actual gain is applied to the image at step S2000. It noted that in the preferred embodiment it takes approximately 25-30 scanlines to perform the calculation and thus there is an inherent delay before the application of the gain value.

At step S3000, the process collects the histogram data of next four scanlines, and a new gain value is computed. The new gain value is compared by comparator 1004 of FIG. 21 to the old gain value at step S4000 and this new gain value is utilized by an interpolator 1006 of FIG. 21 to generate interpolated gain values at step S5000 only if the new gain value is lower than the previous one. Such a condition is imposed since the objective is to compensate for the integrating cavity effect alone (the integrating cavity effect tends to make lead edge video darker and hence gain is higher than normal). If the new gain value is equal or higher than a previous value, the old gain is applied at step S2000.

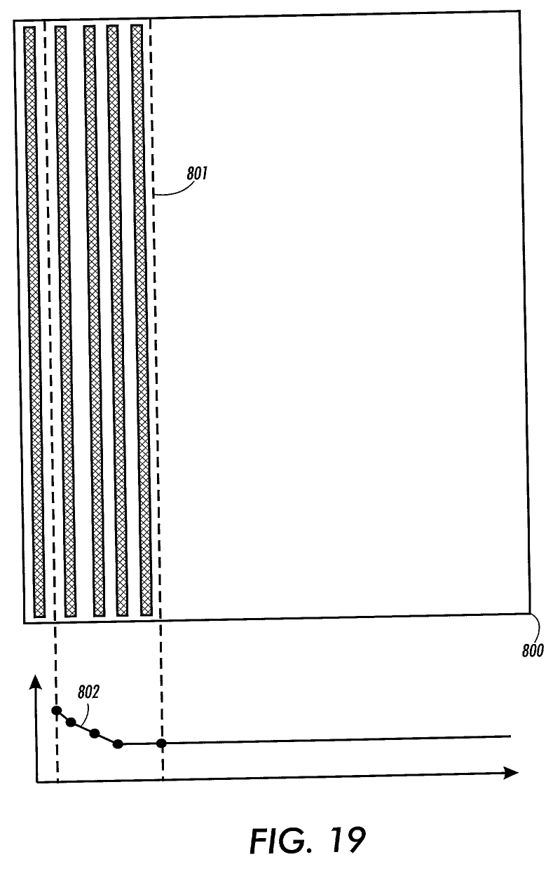

A whole range of gain values is computed at step S5000 by linearly interpolating between the last two gain values. This interpolation is illustrated by 802 of FIG. 19. The interpolated gain values are updated for every “X” scanlines as illustrated in FIG. 19. The interpolation of gain and frequent updates (smaller values of “X”) results in smoother transition of background.

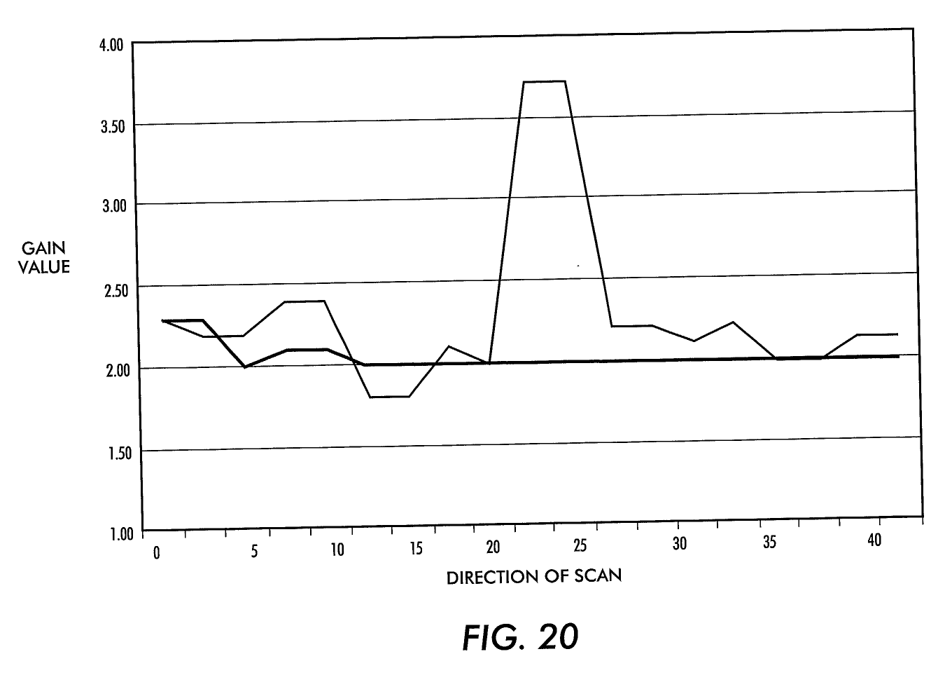

FIG. 20 illustrates the behavior of gain profile when no restriction and interpolation is applied. The gain tends to flicker back and forth which results in visible banding effect in the final printed image if interpolation is not utilized. On the other hand, with the restriction of only decreasing gain values trigger an adaptive response and the application of interpolation of gain between consecutive samples, the gain profile is smoother and the final printed image does not show any visible artifact.

In a preferred embodiment, this process is repeated for a predetermined portion of the document. In the preferred embodiment, a predetermined portion that is 18 millimeters gave good results because such a portion insures that the video value is accurate. This predetermined portion could be a NVM programmable register that could be set to any desired value.

The above described process enables the present invention to pick up the white spots in the text area and to suppress the background appropriately.

While this invention has been described above in conjunction with specific embodiments, it is evident that many alternatives, modifications and variations will become apparent to those skilled in the art upon consideration of the foregoing description. Accordingly, it is intended that the present invention embrace all such alternatives, modifications and variations as fall within the spirit and broad scope of the appended claims.

What is claimed is:

1. A method of suppressing automatically a background of a document being scanned, comprising the steps of:
(a) generating a histogram from a predetermined group of scanlines of image data collected at a lead edge of the document being scanned;
(b) calculating a gain value from the histogram and applying the gain to the image data;
(c) generating a next histogram from a next predetermined group of scanlines of image data collected from the document being scanned;
(d) calculating a next gain value from the next histogram; and
(e) applying the next gain value to the image data if the next gain value is less than a previously calculated gain value.

2. The method as claimed in claim 1, further comprising the step of:
(f) repeating said steps (c), (d), and (e).

3. The method as claimed in claim 1, further comprising the steps of:
(f) repeating said steps (c), (d), and (e) for a predetermined portion of the document being scanned.

4. The method as claimed in claim 1, wherein the predetermined groups of scanlines are four scanlines each.

5. The method as claimed in claim 3, wherein the predetermined portion of the document is a first eight millimeters of the document.

6. The method as claimed in claim 1, further comprising the steps of:
(f) calculating interpolated gain values for scanlines of image data located between adjacent predetermined groups of scanlines; and
(g) applying the interpolated gain values to associated scanlines of image data located between adjacent predetermined groups of scanlines.

7. The method as claimed in claim 1, wherein a distance between adjacent predetermined groups of scanlines is three millimeters.

8. The method as claimed in claim 4, wherein a distance between adjacent predetermined groups of scanlines is three millimeters.

9. The method as claimed in claim 5, wherein a distance between adjacent predetermined groups of scanlines is three millimeters.

10. A system of suppressing automatically a background of a document being scanned, comprising:
a histogram circuit to generate a histogram from a predetermined group of scanlines of image data collected at a lead edge of the document being scanned;
a gain correction circuit to calculate a gain value from the histogram and applying the gain to the image data;
said histogram circuit generating a next histogram from a next predetermined group of scanlines of image data collected from the document being scanned;
said gain correction circuit calculating a next gain value from the next histogram; and
a comparator to apply the next gain value to the image data if the next gain value is less than a previously calculated gain value.

11. The system as claimed in claim 10, wherein the predetermined groups of scanlines are four scanlines each.

12. The system as claimed in claim 10, wherein a distance between adjacent predetermined groups of scanlines is three millimeters.

13. The system as claimed in claim 10, further comprising:
an interpolator to calculate interpolated gain values for scanlines of image data located between adjacent predetermined groups of scanlines and to apply the interpolated gain values to associated scanlines of image data located between adjacent predetermined groups of scanlines.
